(19) United States
(12) Patent Application Publication
(10) Pub. No.: US 2024/0272641 A1
(43) Pub. Date: Aug. 15, 2024

(54) DRIVING ASSISTANT DEVICE, DRIVING ASSISTANT SYSTEM, AND DRIVING ASSISTANT METHOD

(71) Applicant: Panasonic Intellectual Property Management Co., Ltd., Osaka (JP)

(72) Inventor: Satoshi FUKUMOTO, Tokyo To (JP)

(73) Assignee: Panasonic Intellectual Property Management Co., Ltd., Osaka (JP)

(21) Appl. No.: 18/436,750

(22) Filed: Feb. 8, 2024

(30) Foreign Application Priority Data
Feb. 10, 2023 (JP) 2023-018895

(51) Int. Cl. G05D 1/225; G05D 101/00

(52) U.S. Cl. CPC G05D 1/225; G05D 2101/22

(57) ABSTRACT

An assistant device according to the present disclosure includes a memory, and a hardware processor coupled to the memory. The hardware processor being configured to: add latency information indicating required latency to data that is transmitted to a server of a plurality of servers via a communication line and used for an assistance process performed by the server; transmit data for external processing to which the latency information is added, and receive assistance information including a processing result of the server based on the data for external processing; and control a vehicle based on the assistance information.

### CROSS-REFERENCE TO RELATED APPLICATIONS

This application is based upon and claims the benefit of priority from Japanese Patent Application No. 2023-018895, filed on Feb. 10, 2023, the entire contents of which are incorporated herein by reference.

### FIELD

An embodiment described herein relates generally to a driving assistant device, a driving assistant system, and a driving assistant method.

### BACKGROUND

Techniques have conventionally been known in which various sensors are mounted on a vehicle and driving assistant such as vehicle control is performed using the result of processing based on sensor data from these in-vehicle sensors. For example, Japanese Patent Application Laid-open No. 2020-191605 discloses a technique to perform the processing based on the sensor data using a plurality of servers that communicate with the vehicle through wireless communication via a wireless base station.

For example, if latency increases due to a delay in communication between the vehicle and the servers or concentration of processing requests to the servers, responses from the servers may be too late for the timing of the vehicle control. Although the latency due to the delay in communication can be reduced, for example, by performing the processing using an edge server located near the vehicle or a wireless base station, the number of vehicles that can be accommodated in the same edge server is limited. Therefore, a problem arises that workloads of the servers that perform the processing requested from the vehicles are uneven in cases, such a case where the vehicles are concentrated in a certain area, a case where distances from the vehicle differ among the servers, and a case where processing capability differs among the servers.

The present disclosure aims to solve the problem of equalizing the workloads of a plurality of servers that perform the processing requested from a plurality of vehicles.

### SUMMARY

An assistant device according to the present disclosure includes a memory, and a hardware processor coupled to the memory. The hardware processor being configured to: add latency information indicating required latency to data that is transmitted to a server of a plurality of servers via a communication line and used for an assistance process performed by the server; transmit data for external processing to which the latency information is added, and receive assistance information including a processing result of the server based on the data for external processing; and control a vehicle based on the assistance information.

### BRIEF DESCRIPTION OF THE DRAWINGS

FIG. 1 is a view schematically illustrating an exemplary vehicle on which a driving assistant device according to an embodiment of the present disclosure is mounted;

FIG. 2 is a diagram illustrating an exemplary configuration of a driving assistant system that includes the driving assistant device according to the embodiment;

FIG. 3 is a diagram illustrating an exemplary hardware configuration of devices of the driving assistant system according to the embodiment;

FIG. 4 is a diagram illustrating an exemplary functional configuration of the driving assistant device according to the embodiment;

FIG. 5 is a diagram illustrating an exemplary functional configuration of a router according to the embodiment; and

FIG. 6 is a flowchart illustrating an exemplary flow of an assistance process performed by the driving assistant system according to the embodiment.

### DETAILED DESCRIPTION

The following describes an embodiment of a driving assistant device, a vehicle, a driving assistant system, a driving assistant method, a computer program, and a storage medium according to the present disclosure with reference to the drawings.

In the description of the present disclosure, components having the same or substantially the same function as that described with reference to an already mentioned drawing may be denoted by the same reference numeral, and the description thereof may be omitted as appropriate. Even when the same or substantially the same parts are illustrated, they may be illustrated with dimensions or ratios different from each other between the drawing. For example, from the viewpoint of ensuring the visibility of the drawings, reference numerals may be attached to major components in the explanation of each drawing, and even the components having the same or substantially the same function as that described with reference to an already mentioned drawing may have no reference numerals attached thereto.

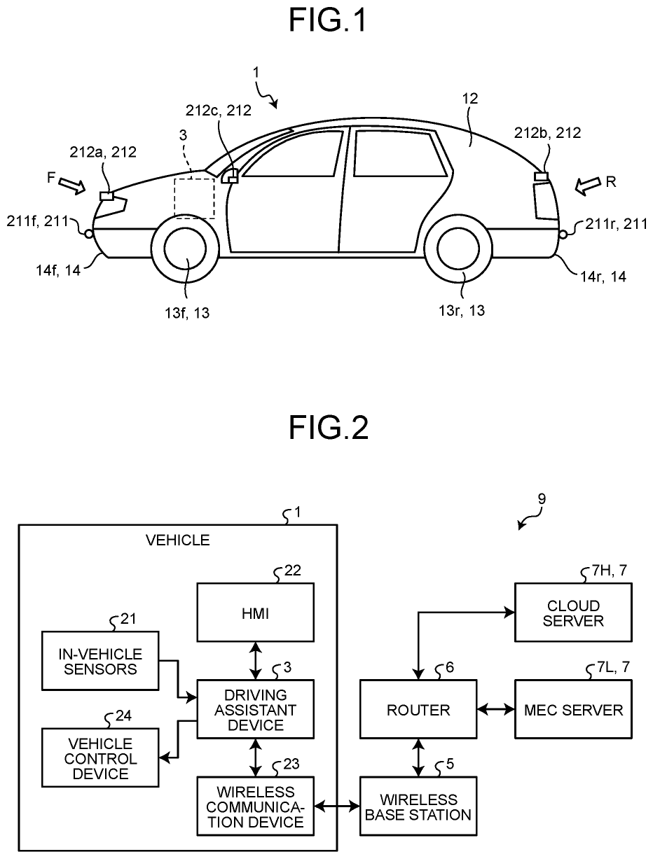

FIG. 1 is a view schematically illustrating an example of a vehicle 1 on which a driving assistant device 3 according to the embodiment is mounted. As illustrated in FIG. 1, the vehicle 1 includes a vehicle body 12 and two pairs of wheels 13 arranged along a predetermined direction on the vehicle body 12. The two pairs of wheels 13 include a pair of front tires 13f and a pair of rear tires 13r.

Herein, each of the front tires 13f according to the embodiment is an example of a first wheel. Each of the rear tires 13r according to the embodiment is an example of a second wheel. FIG. 1 illustrates the vehicle 1 having the four wheels 13, but the vehicle 1 is not limited to having the four wheels 13. The vehicle 1 may have at least one front tire 13f and at least one rear tire 13r. The number of the wheels 13 of the vehicle 1 may be two, three, or five or more.

The direction of at least one wheel (steerable wheel) of the wheels 13 of the vehicle 1 is electrically or mechanically interlinked with, for example, the rotation angle of a steering wheel located in front of a driver's seat 130, in other words, a steering angle. The vehicle 1 can turn right and left by being steered. The steerable wheels may be the rear tires 13r or both the front tires 13f and the rear tires 13r.

The vehicle body 12 is supported by the wheels 13. The vehicle 1 includes a drive machine (not illustrated), and is movable by driving at least one wheel (driving wheel) of the wheels 13 of the vehicle 1 using power of the drive machine. Any drive machine, such as an engine fueled by gasoline or hydrogen, a motor using power from a battery, or a combination of an engine and a motor, is applicable as the drive machine. In this case, the predetermined direction in which the two pairs of wheels 13 are arranged serves as a direction in which the vehicle 1 travels. The vehicle 1 can move forward or backward, for example, by switching gears (not illustrated).

The vehicle body 12 has a front end F that is an end close to the front tires 13f and a rear end R that is an end close to the rear tires 13r. The vehicle body 12 is substantially rectangular in a top view, and the four corners of the substantially rectangular shape may be referred to as ends.

A pair of bumpers 14 are provided at the front and the rear ends F and R of the vehicle body 12 near the lower end of the vehicle body 12. A front bumper 14f of the pair of bumpers 14 covers the entire front surface and portions of the side surfaces near the lower end of the vehicle body 12. A rear bumper 14r of the pair of bumpers 14 covers the entire rear surface and portions of the side surfaces near the lower end of the vehicle body 12.

FIG. 2 is a diagram illustrating an exemplary configuration of a driving assistant system 9 that includes the driving assistant device 3 according to the embodiment. As illustrated in FIG. 2, the driving assistant system 9 includes a wireless base station 5, a router 6, and a plurality of servers 7, in addition to the vehicle 1 on which the driving assistant device 3 is mounted.

The driving assistant system 9 can be built as a server-client system that includes the servers 7 and the driving assistant device 3 as a client that communicates with one of the servers 7 via the wireless base station 5 and the router 6.

The driving assistant system 9 is configured to be capable of performing an assistance process according to the embodiment. Herein, the assistance process according to the embodiment includes a client-side assistance process performed by the driving assistant device 3, an assistance process performed by the router 6, and a server-side assistance process performed by one of the servers 7.

As illustrated in FIG. 2, the vehicle 1 includes in-vehicle sensors 21, a human-machine interface (HMI) 22, a wireless communication device 23, and a vehicle control device 24. Each of the in-vehicle sensors 21, the HMI 22, the wireless communication device 23, and the vehicle control device 24 is connected to the driving assistant device 3 via an in-vehicle network such as a controller area network (CAN) or Ethernet (registered trademark).

Although FIG. 2 illustrates a case where each of the in-vehicle sensors 21, the HMI 22, the wireless communication device 23, and the vehicle control device 24 is not included in the driving assistant device 3, the present disclosure is not limited to this case. One, some, or all of these components may be included in the driving assistant device 3.

The in-vehicle sensors 21 include sonar 211 and an all-around view camera 212, as illustrated in FIG. 1, for example.

The sonar 211 is provided, for example, at predetermined ends of the vehicle body 12, and transmits and receives sound waves such as ultrasonic waves. The sonar 211 includes transceivers 211f and 211r. For example, one or more transceivers 211f are disposed on the front bumper 14f, and one or more transceivers 211r are disposed on the rear bumper 14r. The number and/or positions of the transceivers 211f and 211r are not limited to the example illustrated in FIG. 1, but can be changed as appropriate. For example, the vehicle 1 may be provided with the transceivers 211f and 211r on the right and left sides.

The sonar 211 detects obstacles around the vehicle 1 based on the results of transmission and reception of the sound waves. The sonar 211 also measures the distances between the vehicle 1 and the obstacles around the vehicle 1 based on the results of transmission and reception of the sound waves.

Although the present embodiment exemplifies the sonar 211 that uses the sound waves such as the ultrasonic waves, the present disclosure is not limited to this example. For example, the vehicle 1 may include radar that transmits and receives electromagnetic waves, instead of or in addition to the sonar 211.

The all-around view camera 212 is provided on the vehicle 1 so as to be capable of photographing the surroundings of the vehicle 1. As an example, the vehicle 1 includes, as the all-around view camera 212, a front camera 212a that photographs the front, a rear camera 212b that photographs the rear, a left side camera 212c that photographs the left side, and a right side camera (not illustrated) that photographs the right side.

The all-around view camera 212 captures video images of the surroundings of the vehicle 1. The all-around view camera 212 is, for example, a camera that captures the images based on visible light and/or infrared light. The images captured by the all-around view camera 212 may be video or still images.

The positions and/or number of cameras of the all-around view camera 212 are not limited to the example illustrated in FIG. 1, but can be changed as appropriate. For example, the vehicle 1 may include two cameras including the front camera 212a and the rear camera 212b. Alternatively, the vehicle 1 may further include other cameras in addition to those of the example described above. For example, one, some, or all of the cameras of the all-around view camera 212 may be provided on the vehicle cabin space (vehicle interior) of the vehicle 1. The all-around view camera 212 may be a camera built into the vehicle 1, or it may be, for example, add-on dashboard cameras added onto the vehicle 1.

The in-vehicle sensors 21 include various sensors not illustrated in the drawings. As an example, the in-vehicle sensors 21 include a steering angle sensor that outputs a signal depending on an amount of operation of the steering wheel by the driver, in other words, the steering wheel angle. As an example, the in-vehicle sensors 21 include wheel speed sensors that output signals depending on speeds and directions of rotation of the wheels 13. As an example, the in-vehicle sensors 21 include a brake sensor that detects an amount of operation of the brake pedal by the driver. As an example, the in-vehicle sensors 21 include an accelerator sensor that detects an amount of operation of the accelerator pedal by the driver. As an example, the in-vehicle sensors 21 include an acceleration sensor that outputs a signal depending on an acceleration applied to the vehicle 1. As an example, the in-vehicle sensors 21 include a gyroscope sensor that outputs a signal depending on an angular velocity applied to the vehicle 1. As an example, the in-vehicle sensors 21 include a global navigation satellite system (GNSS) sensor, such as a Global Positioning System (GPS) sensor, that outputs position information on the vehicle 1. The GNSS sensor includes a GNSS antenna that receives radio waves from satellites and a GNSS circuit that obtains position information based on the radio waves from at least two satellites received by the GNSS antenna.

The HMI 22 is an interface for outputting various types of information, such as notifications and warnings, to the driver of the vehicle 1. The HMI 22 is an interface for receiving input of various types of information given by the driver of the vehicle 1. The HMI 22 may be capable of outputting the notifications and the warnings recognizably to the driver of the vehicle 1 and accepting various operations made by the driver of the vehicle 1, and is provided, for example, around the driver's seat of the vehicle 1, but may be provided at a portion other than around the driver's seat, such as around the rear seat.

As an example, the HMI 22 includes a display that is provided on the dashboard or the console of the vehicle 1, and is configured to be capable of outputting video images. The display is, for example, a liquid crystal display (LCD) or an organic electroluminescent (EL) display. The display may be configured as a touchscreen display. The display may also be a portion of an automotive navigation device mounted on the vehicle 1. The display may be a projection display device, such as a head-up display (HUD), that projects video images (virtual images) onto a display area or the like provided in front of the driver, for example, onto the windshield glass or the dashboard (console). The HMI 22 may include other output devices, such as a speaker, configured to be capable of outputting notification sounds, warning sounds, and voices.

As an example, the HMI 22 includes a touch panel of a touchscreen display as an input device. The HMI 22 may include other input devices such as buttons, dials, switches, and microphones. These input devices are located on, for example, the dashboard, the instrument panel, the steering wheel, and/or the console of the vehicle 1.

Operation terminals, such as a tablet computer, a smartphone, a remote controller, and an electronic key, that can transmit or transmit and receive signals to the vehicle 1 from outside the vehicle 1 can be used as the HMI 22.

The wireless communication device 23 transmits and receives wireless signals that transmit information between the vehicle 1 and the wireless base station 5. The wireless communication device 23 includes an antenna (not illustrated), and is configured to be capable of transmitting and receiving the wireless signals between the vehicle 1 and the wireless base station 5 via the antenna. The wireless signals are transmitted and received using any cellular Vehicle-to-everything (V2X) method conforming to the requirements of the International Mobile Telecommunications-2020 (IMT-2020) for, for example, the Fifth Generation Mobile Communication System (5G) and the specifications of the 3rd Generation Partnership Project (3GPP (registered trademark)).

The communication method may be another communication method, such as an IEEE-compliant dedicated short range communication (DSRC) method or a vehicle-to-vehicle/vehicle-to-infrastructure (vehicle-to-cellular-network (V2N)) communication method.

The vehicle control device 24 includes a steering control device and a driving/braking control device.

The steering control device controls the steering of the vehicle 1. The steering control device deflects the wheels 13, for example, in a direction depending on a control signal depending on the amount of operation of the steering wheel by the driver or a control signal from the driving assistant device 3. The steering control device may include a steering actuator (not illustrated) that changes the rotation angle of the steering wheel according to the control signal from the driving assistant device 3.

The driving/braking control device controls the acceleration and the deceleration of the vehicle 1. The driving/braking control device includes, for example, a brake actuator (not illustrated) and an engine controller (not illustrated). The brake actuator brakes the vehicle 1 or decelerates the vehicle 1 by operating the brakes, changing the shift position (gear ratio), or controlling the output of the drive machine such as the engine or the motor based on a detection result of the brake sensor (not illustrated) that detects the amount of operation of the brake pedal by the driver or the control signal from the driving assistant device 3. An accelerator controller accelerates the vehicle 1 by controlling the output of the drive machine such as the engine or the motor based on a detection result of the accelerator sensor (not illustrated) that detects the amount of operation of the accelerator pedal by the driver or the control signal from the driving assistant device 3.

The driving assistant device 3 is an information processing device mountable on the vehicle 1, and is implemented, for example, by an electronic control unit (ECU) or an on-board unit (OBU) provided inside the vehicle 1. Alternatively, the driving assistant device 3 may be an external computer located near the dashboard of the vehicle 1. The driving assistant device 3 may double as the automotive navigation device, for example.

The wireless base station 5 relays communications between each of the vehicles 1 and the router 6. Specifically, the wireless base station 5 transmits and receives the wireless signals that transmit information to and from each of the vehicles 1 in an area covered by the wireless base station 5. The wireless base station 5 is connected to the router 6 via a wired or wireless telecommunication circuit, and transmits and receives information to and from the router 6.

Although FIG. 2 illustrates any one wireless base station 5 to and from which the vehicle 1 transmits and receives the information, the driving assistant system 9 includes a plurality of the wireless base stations 5. Each of the wireless base stations 5 is located in such a way that the area covered by the wireless base station 5 overlaps that of another adjacent wireless base station 5. The area covered by the wireless base station 5 refers herein to a range of position of the vehicle 1 where the information can be transmitted and received. Roadside equipment such as roadside units may be used as the wireless base stations 5.

The router 6 allocates data for external processing received from the vehicle 1 to one of the servers 7 via the wireless base station 5. The router 6 also transmits assistance information received from the servers 7 to the target vehicle 1 via the wireless base station 5.

The “data for external processing” herein may be data in transmission units for the assistance process, the data having been added a latency type in the client-side assistance process. In other words, the data for external processing may be data that is transmitted from the driving assistant device 3 to one of the servers 7 via a telecommunication circuit, and may be data that is provided for the assistance process performed by the server 7.

The unit in which the latency type is added is not limited to the data in transmission units for the assistance process, but may be data in processing units for the assistance process.

The “data in transmission units” or “data in processing units” may be a data set used in various processes performed as the assistance processes, and may include vehicle information such as sensor data acquired from the in-vehicle sensors 21 and parameters read from an internal memory. The “data in transmission units” or the “data in processing units” may include the assistance information that has already been acquired.

The servers 7 are a plurality of server devices that perform processes added from the vehicles 1. Each of the servers 7 receives the data for external processing transmitted from the vehicle 1 from the router 6, and performs processing based on the received data for external processing. Each of the servers 7 also transmits information including the results of the server-side assistance process to the router 6.

Information including the results of the server-side assistance process based on the data for external processing may be referred to as the “assistance information”.

FIG. 2 illustrates a cloud server 7H and a multiaccess edge computing (MEC) server 7L that are included in the servers 7.

The cloud server 7H is, for example, at least one server device that provides cloud computing. The cloud server 7H has characteristics of being low cost while having high latency. In other words, the cloud server 7H is a server device that has a high processing capability, can accommodate a large number of the vehicles 1 in the same server, or is low cost, while being centralized at a distant place.

As an example, the cloud server 7H may be provided in a large-scale data center located in the suburbs, for example.

The cloud server 7H transmits and receives information to and from the router 6 via a telecommunication circuit such as the Internet. The cloud server 7H performs processing based on the data for external processing received from the router 6, in other words, the server-side assistance process. The server-side assistance process performed by the cloud server 7H is a process with loose latency requirements.

The “loose latency requirements” herein may mean that large latency is allowed or that a long delay time is allowed.

As an example, the server-side assistance process by the cloud server 7H may be a high-load artificial intelligence (AI) process.

As an example, the server-side assistance process by the cloud server 7H may be an own-vehicle position estimation process that estimates the position of the vehicle 1.

As an example, the server-side assistance process by the cloud server 7H may be a route generation process that generates a traveling route to be used for automatic driving, automatic parking, and/or navigation by the vehicle 1.

The MEC server 7L is, for example, at least one edge server device that provides edge computing. The MEC server 7L has characteristics of being high cost while having low latency. In other words, the MEC server 7L is a server device that has a limited processing capability, can accommodate a small number of the vehicles 1 in the same server, or is high cost, while being located close and having low latency.

As an example, the router 6 and the MEC server 7L may be located at or near the wireless base station 5 that has relayed the wireless signals from the vehicle 1, for example. The wireless base station 5 that has relayed the wireless signals from the vehicle 1 may be referred to as a specified base station.

The term “near A” herein may refer to, for example, a range where the latency from viewpoint of the vehicle with respect to a process involving communication via A does not exceed a predetermined threshold, or a range where the physical distance from A does not exceed a predetermined threshold.

As an example, the router 6 and the MEC server 7L may be located at or near a switching station that bundles the wireless base stations 5 including receiving base stations, for example. The switching station bundling the wireless base stations 5 including the receiving base stations may be referred to as a specified switching station.

As an example, the router 6 and the MEC server 7L may be located at or near the wireless base station 5 other than the specified base station among the wireless base stations 5 with, for example, the specified switching station serving as a hub.

As an example, the router 6 and the MEC server 7L may be located at or near a switching station located in the same area as the specified switching station among the switching stations connected to the specified switching station via a backbone network, for example. The term “in the same area” herein may refer to, for example, in the same city or in the same prefecture.

As an example, the MEC server 7L may be at least one edge server device connected to the same local area network (LAN) as that of the router 6, for example. The router 6 and the MEC server 7L may not be connected to the same LAN. The router 6 and the MEC server 7L may be located at different locations from each other, such as being located at the specified base station and the specified switching station, respectively.

The MEC server 7L transmits and receives information to and from the router 6 via a telecommunication circuit such as a LAN. The MEC server 7L performs processing based on the data for external processing received from the router 6, in other words, the server-side assistance process. The server-side assistance process performed by the MEC server 7L is a process for which latency requirements are tight.

The “latency requirements are tight” herein may mean that the allowed latency is small or that the allowed delay time is short.

As an example, the server-side assistance process by the MEC server 7L may be a process related to each function of an advanced driving assistant system (ADAS), such as a collision damage reduction braking (autonomous emergency braking (AEB)) process or a sudden acceleration prevention process.

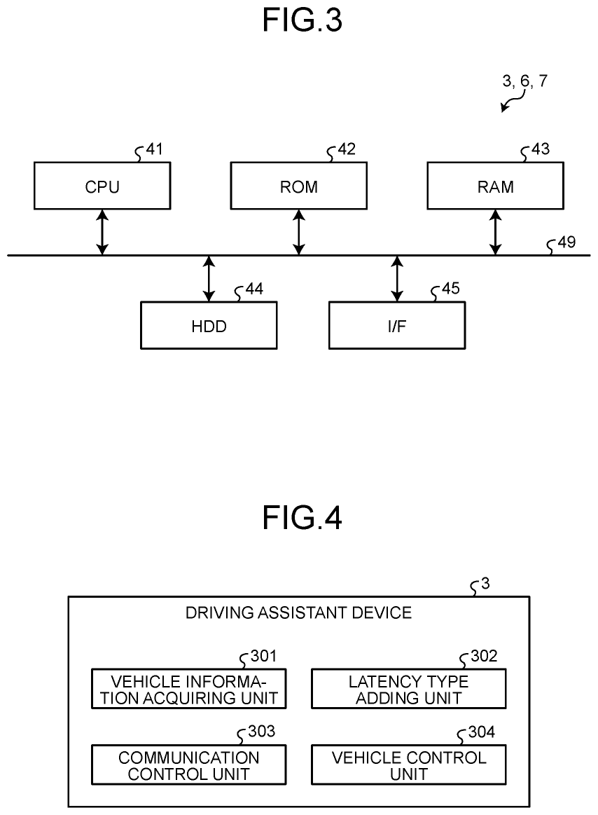

FIG. 3 is a diagram illustrating an exemplary hardware configuration of devices of the driving assistant system 9 according to the embodiment.

As illustrated in FIG. 3, each of the driving assistant device 3, the router 6, and the server 7 includes a central processing unit (CPU) 41, a read-only memory (ROM) 42, a random access memory (RAM) 43, a hard disk drive (HDD) 44, and an interface (I/F) 45. The CPU 41, the ROM 42, the RAM 43, the HDD 44, and the interface (I/F) 45 are interconnected by a bus 49 or the like, and form a hardware configuration using an ordinary computer.

The CPU 41 is an arithmetic device that controls all the devices of the driving assistant system 9. The CPU 41 loads computer programs stored in the ROM 42 and the HDD 44 into the RAM 43, and executes them to perform processes to be described below.

The CPU 41 according to the embodiment is an example of a processor in each of the devices of the driving assistant system 9. Another processor may be provided instead of or in addition to the CPU 41 as such a processor. As the other processor, various processors, such as a graphics processing unit (GPU) and a digital signal processor (DSP), and a dedicated arithmetic circuit implemented as an application-specific integrated circuit (ASIC) or a field-programmable gate array (FPGA) can be used as appropriate.

The ROM 42 stores computer programs, parameters, and the like that implement various processes to be performed by the CPU 41.

The RAM 43 is a main memory of each of the devices of the driving assistant system 9, and temporarily stores data required for the various processes performed by the CPU 41.

The HDD 44 stores various types of data, computer programs, and the like to be used by each of the devices of the driving assistant system 9. Instead of or in addition to the HDD 44, various storage media and storage devices such as a solid-state drive (SSD) and a flash memory can be used as appropriate.

The ROM 42, the RAM 43, and the HDD 44 may each be simply referred to as an “internal memory” when they are not distinguished with one another.

As an example, the internal memory of the driving assistant device 3 may hold the sensor data output from the in-vehicle sensors of the vehicle 1.

As an example, the internal memory of the driving assistant device 3 may hold the assistance information received from the servers 7.

As an example, the internal memory of the driving assistant device 3 may store type information, such as a table indicating a correspondence between each of a plurality of the assistance processes for the vehicle 1 and the latency type defined in advance for the process.

The “latency type” herein may be information indicating the class of the required latency. The latency types may be two classes, such as “high” and “low,” or may be three or more classes. These classes may or may not correspond to the types of the servers 7.

As an example, the internal memory of the router 6 may store allocation information, such as a table indicating a correspondence between the predefined latency types and the servers 7.

An I/F 35 is an interface for sending and receiving data.

As an example, the I/F 45 of the driving assistant device 3 may receive data from other devices provided on the vehicle 1, such as the in-vehicle sensors 21, the HMI 22, and the wireless communication device 23. The I/F 45 of the driving assistant device 3 may also transmit data to other devices provided on the vehicle 1, such as the HMI 22, the wireless communication device 23, and the vehicle control device 24.

The I/F 45 of the driving assistant device 3 may transmit and receive information to and from other ECUs mounted on the vehicle 1 via an in-vehicle network such as a CAN on the vehicle 1, or may communicate with an information processing device outside the vehicle 1 via a network such as the Internet.

As an example, the I/F 45 of the driving assistant device 3 may acquire information on the state of the vehicle 1, such as vehicle speed pulses, angular velocities including a yaw rate, the acceleration, the position information, shift information, from other ECUs, for example, via the in-vehicle network such as the CAN.

FIG. 4 is a diagram illustrating an exemplary functional configuration of the driving assistant device 3 according to the embodiment. The driving assistant device 3 performs functions as a vehicle information acquiring unit 301, a latency type adding unit 302, a communication control unit 303, and a vehicle control unit 304 by causing the CPU 41 to execute the computer program loaded into the RAM 43.

The vehicle information acquiring unit 301 acquires various types of data to be used for the assistance process. The vehicle information acquiring unit 301 herein is an example of an acquiring unit.

As an example, the vehicle information acquiring unit 301 may acquire the sensor data from the in-vehicle sensors of the vehicle 1, such as the sonar 211 and the all-around view camera 212, via the I/F 35, for example.

The latency type adding unit 302 adds latency information indicating the required latency to the data to be used for the server-side assistance process. The latency type adding unit 302 herein is an example of an adding unit.

As an example, the latency type adding unit 302 may add the latency information depending on a processing content of the server-side assistance process.

The communication control unit 303 controls the wireless communication with the wireless base station 5 performed by the wireless communication device 23. Herein, the communication control unit 303 according to the embodiment is an example of a communication unit or a first communication unit.

As an example, the communication control unit 303 may transmit the data for external processing that is added the latency type to the router 6 via the wireless communication through the wireless base station 5.

As an example, the communication control unit 303 may receive the assistance information from the router 6 via the wireless communication through the wireless base station 5.

The vehicle control unit 304 controls at least one of the steering, the braking, and the acceleration/deceleration of the vehicle 1. Herein, the vehicle control unit 304 according to the embodiment is an example of a control unit.

As an example, the vehicle control unit 304 may control the vehicle 1 based on the assistance information given by the server-side assistance process.

As an example, the vehicle control unit 304 may limit the scope of control of the vehicle 1 if the latency requirements depending on the latency type are not satisfied.

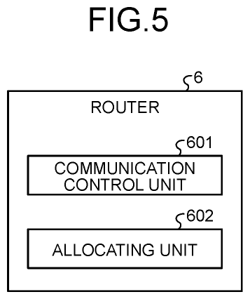

FIG. 5 is a diagram illustrating an exemplary functional configuration of the router 6 according to the embodiment. The router 6 performs functions as a communication control unit 601 and an allocating unit 602 by causing the CPU 41 to execute the computer program loaded into the RAM 43.

The communication control unit 601 controls wireless communication with the wireless base station 5. The communication control unit 601 also controls communication with each of the servers 7. The communication control unit 303 herein is an example of a second communication unit.

The allocating unit 602 allocates the data for external processing to one of the servers 7. The allocating unit 602 herein is an example of a selecting unit.

As an example, the allocating unit 602 may allocate the data for external processing to one of the servers 7 according to the latency type added to the data for external processing.

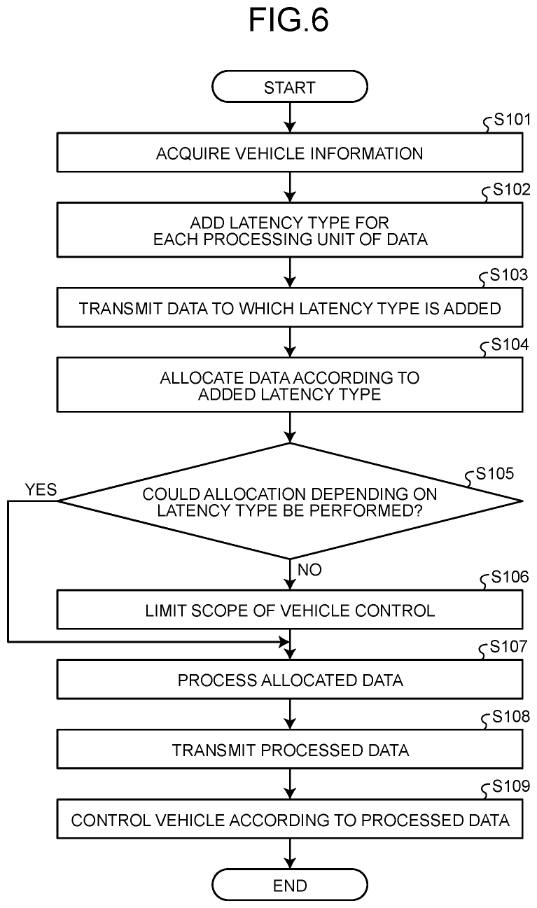

The following describes a flow of the assistance process performed by the driving assistant system 9 configured as described above. FIG. 6 is a flowchart illustrating an example of the flow of the assistance process performed by the driving assistant system 9 according to the embodiment.

First, the driving assistant system 9 acquires the vehicle information (S101). Specifically, in the client-side assistance process, the vehicle information acquiring unit 301 of the driving assistant device 3 acquires the vehicle information, for example, via the in-vehicle network such as the CAN.

The vehicle information is information that is used for each of the processes related to the driving assistant, and includes, for example, the sensor data output from the in-vehicle sensors 21. The vehicle information may include various types of information on the vehicle 1, in addition to the sensor data.

The driving assistant system 9 adds the latency type for each transmission unit of the data, such as a transmitted packet (S102). Specifically, in the client-side assistance process, the latency type adding unit 302 of the driving assistant device 3 uses the vehicle information acquired by the vehicle information acquiring unit 301 to generate the data set required for each of the processes, in other words, the data in processing units. The latency type adding unit 302 generates the data for external processing by adding the latency type depending on the purpose of the processing to the data in transmission units such as the packet or the data in processing units, with reference to the type information stored in the internal memory.

The driving assistant system 9 transmits the data for external processing, in other words, the data added the latency type, from the driving assistant device 3 to the router 6 (S103). Specifically, in the client-side assistance process, the communication control unit 303 of the driving assistant device 3 outputs the data for external processing generated by the latency type adding unit 302 to the wireless base station 5 using the wireless communication device 23. The wireless base station 5 relays and supplies the data for external processing transmitted from the driving assistant device 3 of the vehicle 1 to the router 6. The communication control unit 601 of the router 6 acquires the data for external processing from the driving assistant device 3.

The driving assistant system 9 allocates the processing of the data for external processing to one of the servers 7 according to the latency type added to the data for external processing (S104). Specifically, the allocating unit 602 of the router 6 identifies the server 7 to be requested to process the data for external processing, with reference to the allocation information stored in the internal memory. The communication control unit 601 of the router 6 outputs a processing request to the allocation target server 7 identified by the allocating unit 602. In the server-side assistance process, the server 7 that has received the processing request from the router 6 outputs a response indicating whether the requested processing can be performed.

If the router 6 receives the response from the server 7 stating that the processing cannot be performed, the router 6 identifies another of the servers 7 depending on the latency type, and makes a processing request to the identified server 7 in the same manner.

If the router 6 receives the response from the server 7 stating that the processing cannot be performed, and if no other server 7 depending on the latency type is present, the router 6 identifies another of the servers 7 that satisfies the latency requirements depending on the latency type, and makes a processing request to the identified server 7 in the same manner.

If the router 6 receives the response from the server 7 stating that the processing cannot be performed, and if no other server 7 is present that satisfies the latency requirements depending on the latency type, the router 6 allocates the processing of the data for external processing to another of the servers 7 that does not satisfy the latency requirements. In this case, the router 6 outputs a notification stating that allocation satisfying the latency requirements could not be performed, to the driving assistant device 3 via the wireless base station 5.

The driving assistant system 9 determines whether the allocation depending on the latency type added to the data for external processing could be performed (S105). Specifically, in the client-side assistance process, the communication control unit 303 of the driving assistant device 3 determines whether the notification stating that allocation satisfying the latency requirements could not be performed has been received from the router 6.

If the allocation depending on the latency type could be performed (Yes at S105), the flow in FIG. 6 proceeds to processing at S107.

If, instead, the allocation depending on the latency type could not be performed (No at S105), the driving assistant system 9 limits the scope of vehicle control (S106). Specifically, in the client-side assistance process, the vehicle control unit 304 of the driving assistant device 3 limits the scope of the vehicle control if the communication control unit 303 has received the notification stating that allocation satisfying the latency requirements could not be performed from the router 6.

As an example, the vehicle control unit 304 may limit the scope of speed control of the vehicle 1 so as to allow the vehicle 1 to travel within a safe limits. For example, the vehicle control unit 304 may reduce the vehicle speed to a predetermined speed. For example, if the notification from the router 6 includes information on the server 7 to which the processing is allocated, the vehicle control unit 304 may reduce the vehicle speed to a speed depending on the latency of the server 7 to which the processing is allocated.

The driving assistant system 9 performs the processing of the data for external processing that has been allocated according to the latency type (S107). Specifically, in the server-side assistance process, the server 7 that has received the processing request from the router 6 performs the processing based on the data for external processing.

The driving assistant system 9 transmits the processed data from the server 7 to the target vehicle 1 (S108). Specifically, in the server-side assistance process, the server 7 that has processed the data for external processing that has been allocated according to the latency type outputs the assistance information including the processing result to the router 6. The communication control unit 601 of the router 6 transmits the received assistance information to the target vehicle 1 via the wireless base station 5. In the client-side assistance process, the communication control unit 303 of the driving assistant device 3 acquires the assistance information from the server 7.

The driving assistant system 9 controls the vehicle 1 according to the processed data (S109). Specifically, in the client-side assistance process, the vehicle control unit 304 of the driving assistant device 3 cancel the limitation to the scope of the vehicle control if the limitation has been set. The vehicle control unit 304 controls the vehicle 1 based on the assistance information received by the communication control unit 303 from the server 7. Then, the flow in FIG. 6 ends.

The driving assistant device 3 and the router 6 according to the embodiment may be configured as an integrated unit. In other words, the communication control unit 601 and the allocating unit 602 according to the embodiment may be implemented by the driving assistant device 3.

The router 6 and the MEC server 7L according to the embodiment may be configured as an integrated unit. In other words, the communication control unit 601 and the allocating unit 602 according to the embodiment may be implemented by the MEC server 7L. The integrally configured router 6 and MEC server 7L herein are an example of a first server.

The assistance process according to the embodiment is not limited to the process related to the driving assistant of the vehicle 1, but may also be a process related to in-vehicle infotainment (IVI) functions. The vehicle information may also include data output from the input devices of the HMI 22 in response to a user operation. As an example, the server-side assistance process by the cloud server 7H may be a process, such as background processing, that does not affect screen transitions in the IVI functions, in other words, a process allowed to make a low response. As an example, the server-side assistance process by the MEC server 7L may be a process, such as a response to a screen tap by the user or a game service, that affects screen transitions in the IVI functions, in other words, a process required to make a high response.

In the assistance process according to the embodiment, the latency types may be added according to controlled objects of the assistance process, such as the vehicle speed, shifting, steering, and braking. As an example, if at least one of the vehicle speed, the steering, and the braking is included in the controlled objects of the assistance process, a latency type requiring low latency may be added. As an example, if the shifting is included in the controlled objects of the assistance process, a latency type that allows high latency may be added.

In the assistance process according to the embodiment, the latency types may be added according to the types of the in-vehicle sensors 21 that have output the sensor data. As an example, the data for external processing that includes the sensor data from the sonar 211 may be added a latency type that requires low latency. As an example, the data for external processing that includes image data from the all-around view camera 212 may be added a latency type that allows high latency.

In the assistance process depending on the embodiment, the latency type is not limited to a fixed latency type depending on the processing content, the controlled objects, sensor types, and the like, but may be dynamically added.

For example, the latency type may be added according to the state of the vehicle 1, such as the vehicle speed, the shifting, and an accelerator opening degree. As an example, when the vehicle speed is high, the shift position is on the high-speed side, or the accelerator opening degree is large, a latency type requiring low latency may be added.

For example, the latency type may be added according to the conditions around the vehicle 1, in other words, the surrounding environment, recognized by the in-vehicle sensors 21 and the cloud server 7H. As an example, a latency type requiring low latency may be added when a person or an object is detected around the vehicle 1, or when the vehicle 1 is traveling on a narrow path with poor visibility.

In the assistance process according to the embodiment, the latency type may be added according to two or more of the following: the processing content, the state of the vehicle 1, the sensor types, and the surrounding environment.

As an example, the latency type may be a fixed latency type set in advance with respect to at least one of the following: the processing content, the controlled object, and the sensor type, or the fixed latency type may be dynamically changed according to at least one of the state of the vehicle 1 and the surrounding environment.

In the assistance process according to the embodiment, it is not limited to the latency type indicating the class of the required latency, but an allowable delay time indicating the allowable latency may be added. Herein, each of the latency type and the allowable delay time according to the embodiment is an example of the latency information.

In the assistance process according to the embodiment, the allocating unit 602 may perform the allocation not according to the latency type but according to the allowable delay time. As an example, the allocating unit 602 may identify the allocation target server 7 based on a predetermined threshold that is determined in advance and held in the internal memory and the allowable delay time added to the data for external processing.

For example, if the added allowable delay time exceeds the predetermined threshold, in other words, in a situation where the allowable delay time is long, the allocating unit 602 may allocate a process, such as the AEB process, that has been supposed be allocated to the MEC server 7L in the embodiment described above, to the cloud server 7H. For example, if the added allowable delay time is shorter than the predetermined threshold, in other words, in a situation where the allowable delay time is short, the allocating unit 602 may allocate a process, such as the route generation process, that has been supposed to be allocated to the cloud server 7H in the embodiment described above, to the MEC server 7L.

Thus, the driving assistant system 9 according to the embodiment is configured to add the latency information indicating the required latency to the data to be used for the server-side assistance process. In other words, the driving assistant device 3 is configured to add the latency information to the uploaded data. The driving assistant system 9 is configured to allocate the data for external processing to the server 7, among the servers 7, that satisfies the latency requirements depending on the added latency information.

With this configuration, the server 7 to perform the assistance process can be selected from the servers 7 that satisfy the latency requirements so that costs can be minimized in the servers 7. In other words, the server 7 to perform the process can be switched among the servers 7 based on the added latency information. Therefore, according to the configuration described above, workloads of the servers 7 can be equalized, for example, by increasing the number of the vehicles 1 that can be accommodated in the same MEC server 7L by reducing the number or amount of processes to be processed by the distance-limited MEC server 7L, and by using the large-scale cloud server 7H.

In the embodiment described above, “to determine whether something is A” may mean to determine that something is A, or to determine that something is not A, or to determine whether something is A or not.

Each computer program executed by each of the devices (driving assistant device 3, router 6, cloud server 7H, and MEC server 7L) of the driving assistant system 9 according to the embodiment described above is provided by being recorded as a file in an installable or executable format on a computer-readable storage medium such as a compact disc read-only memory (CD-ROM), a floppy disk (FD), a compact disc-recordable (CD-R), or a digital versatile disc (DVD).

Each computer program executed by each of the devices of the driving assistant system 9 according to the embodiment described above may be stored on a computer connected to a network such as the Internet, and may be provided by being downloaded via the network. Each computer program executed by each of the devices of the driving assistant system 9 according to the embodiment described above may be provided or distributed via a network such as the Internet.

Each computer program executed by each of the devices of the driving assistant system 9 according to the embodiment described above may be provided by being incorporated into a ROM or the like in advance.

The computer program executed by each of the devices of the driving assistant system 9 according to the embodiment described above has a module configuration including the functional components described above, and as actual hardware, a CPU 31 reads the computer program from a ROM 32 or an HDD 34 and executes it to load the functional components described above into a RAM 33, so that each functional component described above are generated on the RAM 33.

According to at least one embodiment described above, the workloads of the servers that perform the processing requested from the vehicles can be equalized.

According to the present disclosure, the workloads of a plurality of servers that perform the processing requested from a plurality of vehicles can be equalized.

While certain embodiments have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

### Notes

The following technique is disclosed by the description of the above embodiment.

(1)

An assistant device including:
an adding unit configured to add latency information indicating required latency to data that is transmitted to a server of a plurality of servers via a communication line and used for an assistance process performed by the server;
a communication unit configured to transmit data for external processing to which the latency information is added, and receive assistance information including a processing result of the server based on the data for external processing; and
a control unit configured to control a vehicle based on the assistance information.
   (2)

The assistant device according to the above (1), wherein the adding unit is configured to add the latency information depending on a processing content of the assistance process.

(3)

The assistant device according to the above (1) or the above (2), wherein the adding unit is configured to add the latency information depending on a state of the vehicle.

(4)

The assistant device according to any of the above (1) to the above (3), wherein the adding unit is configured to add the latency information depending on a controlled object of the assistance process.

(5)

The assistant device according to any of the above (1) to the above (4), wherein the adding unit is configured to add the latency information depending on a sensor type of an in-vehicle sensor of the vehicle, the in-vehicle sensor outputting sensor data included in the data for external processing.

(6)

The assistant device according to any of the above (1) to the above (5), wherein the adding unit is configured to add the latency information depending on a surrounding environment of the vehicle.

(7)

The assistant device according to any of the above (1) to the above (6), wherein the control unit is configured to limit a scope of control of the vehicle when a latency requirement depending on the latency information is not satisfied.

(8)

The assistant device according to any of the above (1) to the above (7), wherein the data for external processing includes sensor data output from an in-vehicle sensor of the vehicle.

(9)

The assistant device according to any of the above (1) to the above (8), wherein the data for external processing includes data output from an input device in response to a user operation.

(10)

The assistant device according to any of the above (1) to the above (9), wherein the adding unit is configured to add the latency information for each transmission unit or each processing unit with respect to the data for external processing.

(11)

The assistant device according to any of the above (1) to the above (10), wherein the latency information is one of a latency type indicating a class of the required latency, and an allowable delay time indicating allowable latency.

(12)

A vehicle including:
the assistant device according to any of the above (1) to the above (11); and
a control device configured to control at least any of a steering angle, driving, and braking, based on the assistance information from the assistant device.
   (13)

A vehicle including:
the assistant device according to any of the above (1) to the above (11); and
at least one of sonar, an all-around view camera, a steering angle sensor, a wheel speed sensor, a direction sensor, and a GNSS sensor.
   (14)

A vehicle including:
the assistant device according to any of the above (1) to the above (11); and
an input device configured to receive a user operation.
   (15)

The assistant device according to any of the above (1) to the above (14), further including an allocating unit configured to allocate the data for external processing to the server of the plurality of servers according to the latency information added to the data for external processing.

(16)

The assistant device according to any of the above (1) to the above (15), wherein
the latency information is an allowable delay time indicating allowable latency, and
the allocating unit is configured to allocate the data for external processing to the server of the plurality of servers according to the allowable delay time.
   (17)

An assistant system including:
the assistant device or the vehicle according to any of the above (1) to the above (14);
a router configured to allocate the data for external processing to the server of the plurality of servers according to the latency information added to the data for external processing; and
the plurality of servers.
   (18)

An assistant system including:
the assistant device or the vehicle according to any of the above (1) to the above (14); and
the plurality of servers, wherein
a first server of the plurality of servers is configured to allocate the data for external processing to the server of the plurality of servers according to the latency information added to the data for external processing.
   (19)

An assistant method including:
adding latency information indicating required latency to data that is transmitted to a server of a plurality of servers via a communication line and used for an assistance process performed by the server;
transmitting data for external processing to which the latency information is added;
receiving assistance information including a processing result of the server based on the data for external processing; and
controlling a vehicle based on the assistance information.
   (20)

The assistant method according to the above (19), including adding the latency information depending on a processing content of the assistance process.

(21)

The assistant method according to the above (19) or the above (20), including adding the latency information depending on a state of the vehicle.

(22)

The assistant method according to any of the above (19) to the above (21), including adding the latency information depending on a sensor type of an in-vehicle sensor of the vehicle, the in-vehicle sensor outputting sensor data included in the data for external processing.

(23)

The assistant method according to any of the above (19) to the above (22), including adding the latency information depending on a surrounding environment of the vehicle.

(24)

The assistant method according to any of the above (19) to the above (21), including limiting a scope of control of the vehicle when a latency requirement depending on the latency information is not satisfied.

(25)

The assistant method according to any of the above (19) to the above (24), wherein the data for external processing includes sensor data output from an in-vehicle sensor of the vehicle.

(26)

The assistant method according to any of the above (19) to the above (25), wherein the data for external processing includes data output from an input device in response to a user operation.

(27)

The assistant method according to any of the above (19) to the above (26), including adding the latency information for each transmission unit of data with respect to the data for external processing.

(28)

The assistant method according to any of the above (19) to the above (27), including adding the latency information for each processing unit of data with respect to the data for external processing.

(29)

The assistant method according to any of the above (19) to the above (28), wherein the latency information is a latency type indicating a class of the required latency, or an allowable delay time indicating allowable latency.

(30)

The assistant method according to any of the above (19) to the above (29), including allocating the data for external processing to the server of the plurality of servers according to the latency information added to the data for external processing.

(31)

A computer program for causing a computer to execute the assistant method according to any of the above (19) to the above (30).

(32)

A storage medium (computer program product) on which the computer program to be executed by a computer, according to the above (31) is recorded.

What is claimed is:

1. An assistant device comprising:
a memory; and
a hardware processor coupled to the memory,
the hardware processor being configured to:
add latency information indicating required latency to data that is transmitted to a server of a plurality of servers via a communication line and used for an assistance process performed by the server;
transmit data for external processing to which the latency information is added, and receive assistance information including a processing result of the server based on the data for external processing; and
control a vehicle based on the assistance information.

2. The assistant device according to claim 1, wherein the hardware processor is configured to add the latency information depending on a processing content of the assistance process.

3. The assistant device according to claim 1, wherein the hardware processor is configured to add the latency information depending on a state of the vehicle.

4. The assistant device according to claim 1, wherein the hardware processor is configured to add the latency information depending on a controlled object of the assistance process.

5. The assistant device according to claim 1, wherein the hardware processor is configured to add the latency information depending on a sensor type of an in-vehicle sensor of the vehicle, the in-vehicle sensor outputting sensor data included in the data for external processing.

6. The assistant device according to claim 1, wherein the hardware processor is configured to add the latency information depending on a surrounding environment of the vehicle.

7. The assistant device according to claim 1, wherein the hardware processor is configured to limit a scope of control of the vehicle when a latency requirement depending on the latency information is not satisfied.

8. The assistant device according to claim 1, wherein the data for external processing includes sensor data output from an in-vehicle sensor of the vehicle.

9. The assistant device according to claim 1, wherein the data for external processing includes data output from an input device in response to a user operation.

10. The assistant device according to claim 1, wherein the hardware processor is configured to add the latency information for each transmission unit or each processing unit of data with respect to the data for external processing.

11. The assistant device according to claim 1, wherein the latency information is one of a latency type indicating a class of the required latency, and an allowable delay time indicating allowable latency.

12. The assistant device according to claim 1, wherein the hardware processor is further configured to allocate the data for external processing to the server of the plurality of servers according to the latency information added to the data for external processing.

13. The assistant device according to claim 12, wherein
the latency information is an allowable delay time indicating allowable latency, and
the hardware processor is configured to allocate the data for external processing to the server of the plurality of servers according to the allowable delay time.

14. An assistant system comprising:
the assistant device according to claim 1; and
a router configured to allocate the data for external processing to the server of the plurality of servers according to the latency information added to the data for external processing; and
the plurality of servers.

15. An assistant system comprising:
the assistant device according to claim 1; and
the plurality of servers, wherein
a first server of the plurality of servers is configured to allocate the data for external processing to the server of the plurality of servers according to the latency information added to the data for external processing.

16. An assistant method comprising:
adding latency information indicating required latency to data that is transmitted to a server of a plurality of servers via a communication line and used for an assistance process performed by the server;
transmitting data for external processing to which the latency information is added;
receiving assistance information including a processing result of the server based on the data for external processing; and
controlling a vehicle based on the assistance information.

17. The assistant method according to claim 16, further comprising:
adding the latency information depending on a processing content of the assistance process.

18. The assistant device according to claim 16, further comprising:
adding the latency information depending on a state of the vehicle.

19. The assistant device according to claim 16, further comprising:
adding the latency information depending on a controlled object of the assistance process.

20. The assistant device according to claim 16, further comprising:
adding the latency information depending on a sensor type of an in-vehicle sensor of the vehicle, the in-vehicle sensor outputting sensor data included in the data for external processing.
